(19) United States
(12) Patent Application Publication
(10) Pub. No.: US 2007/0091221 A1
(43) Pub. Date: Apr. 26, 2007

(54) LIQUID CRYSTAL DISPLAY DEVICE

(75) Inventors: Lin-Yun Hong, Shenzhen (CN); Hsuan-Chen Chen, Tu-Cheng (TW); Chien-Li Tsai, Tu-Cheng (TW); Chun-Chi Liang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,574

(22) Filed: Aug. 25, 2006

(30) Foreign Application Priority Data
Oct. 24, 2005 (CN) 200520066219.8

(51) Int. Cl. G02F 1/1333

(52) U.S. Cl. 349/58

(57) ABSTRACT

A liquid crystal display device includes a bracket, and a liquid crystal display panel. The bracket includes a bezel, and a cover mounted to the bezel. One of the bezel and the cover includes an elastic member mounted to a side thereof. A side of the liquid crystal display panel is mounted to the elastic member.

### FIELD OF THE INVENTION

The present invention relates to Liquid Crystal Display (LCD) devices, and particularly to an LCD device having an LCD panel readily installed or removed.

### DESCRIPTION OF RELATED ART

A typically folded electronic device, such as a notebook computer, includes a main system, and a monitor pivotably mounted to the main system. The monitor includes a bracket, and an LCD panel. A plurality of screw holes is defined in opposite sides of the LCD panel. A plurality of through-holes is defined in opposite sides of the bracket. Screws are inserted through the through-holes to engage in the corresponding screw holes to secure the LCD panel to the bracket.

In the above-noted disclosed technology, however, the screws directly mount the LCD panel to the bracket, which may not absorb vibration during handling of the folded electronic device.

In Taiwan Patent No. 478603, a monitor of a notebook computer includes a cover, a bezel, an LCD panel, a pair of elastic members, and a plurality of screws. In assembling the LCD panel, the elastic members are mounted to opposite sides of the LCD panel via a plurality of screws. The elastic members are mounted to opposite sides of the cover via a plurality of screws, too. Then, the bezel is mounted to the cover via a plurality of screws. The elastic members mounted between the bracket and the LCD panel can absorb vibration to protect the LCD panel. However, this way of securing the LCD panel uses so many screws, which is unduly painstaking and time-consuming.

What is desired, therefore, is an LCD device which readily allows installation or removal of an LCD panel.

### SUMMARY OF THE INVENTION

An exemplary A liquid crystal display device includes a bracket, and a liquid crystal display panel. The bracket includes a bezel, and a cover mounted to the bezel. One of the bezel and the cover includes an elastic member mounted to a side thereof. A side of the liquid crystal display panel is mounted to the elastic member.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a folded electronic device in accordance with a preferred embodiment of the present invention, the folded electronic device includes a bezel, a cover, and an LCD panel;

FIG. 2 is an enlarged view of a circled portion II of FIG. 1;

FIG. 3 is an assembled view of the cover and the LCD panel of FIG. 1, but viewed from another aspect; and

FIG. 4 is an assembled view of FIG. 1, but viewed from another aspect.

### DETAILED DESCRIPTION OF THE INVENTION

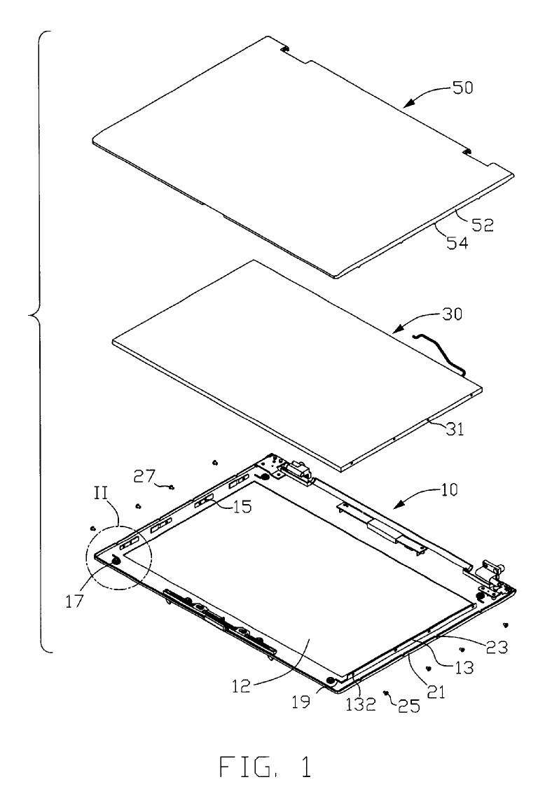

Referring to FIG. 1, a liquid crystal display (LCD) device in accordance with a preferred embodiment of the present invention includes a bezel 10, a cover 50, and an LCD panel 30 defining a plurality of locking holes 31 in opposite sides thereof.

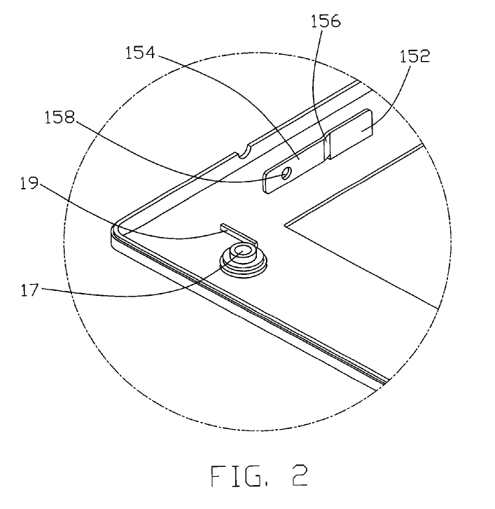

Referring also to FIG. 2, the bezel 10 defines an opening 12 therein. A mounting plate 13 extends up from the bezel 10 at a side of the opening 12. A plurality of through-holes 132 is defined in the mounting plate 13. A plurality of elastic members 15 is mounted to the bezel 10 at an opposite side of the opening 12. Each elastic member 15 includes a fixing portion 152 mounted to the bezel 10, a free elastic portion 154, and a slanting connecting portion 156 connected between the fixing portion 152 and the elastic portion 154. A through-hole 158 is defined in the elastic portion 154 of each elastic member 15. Four mounting holes 17 are defined in the bezel 10 at four corners, respectively. Four orientating tabs 19 perpendicular to the mounting plate 13 extend up from the bezel 10 adjacent four corners of the opening 12. Two flanges 21 parallel to the mounting plate 13 extend up from opposite sides of the bezel 10. A plurality of avoiding cutouts 23 is defined in the flanges 21. Avoiding cutouts 23 of one flange of the flanges 21 aligns with the through-holes 158 of the corresponding elastic members 15. Avoiding cutouts 23 of the other flange of the flanges 21 aligns with the corresponding through-holes 132 of the mounting plate 13.

The cover 50 includes two flanges 52 perpendicularly extending from opposite sides thereof toward the bezel 10. A plurality of covering tabs 54 extends from each flange 52. Each covering tab 54 corresponds to a cutout 23 of the flanges 21. Four poles (not shown) each defining a screw hole extend down from four corners of the cover 50, respectively.

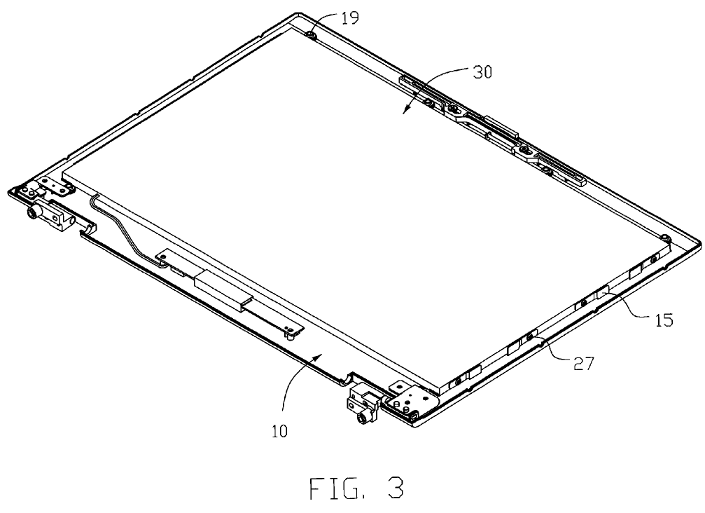

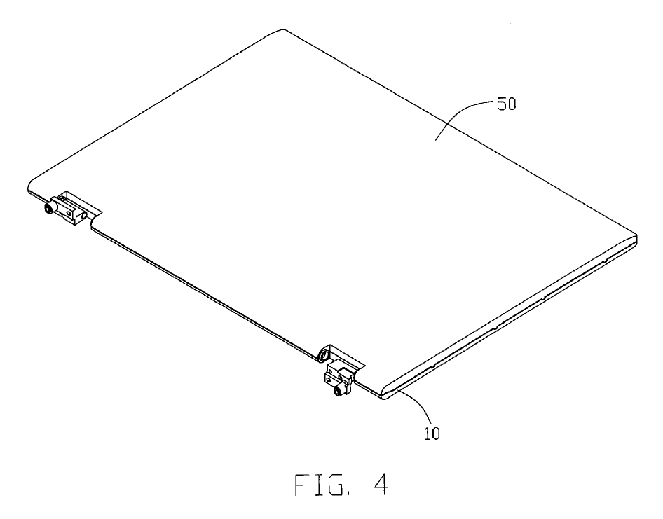

Referring also to FIGS. 3 and 4, in assembly, the LCD panel 30 is accommodated among the orientating tabs 19, the mounting plate 13, and the elastic members 15. Screws 25 are inserted through the through-holes 132 of the mounting plate 13 to engage in the corresponding locking holes 31 of one side of the LCD panel 30. Screws 27 are inserted through the through-holes 158 of the corresponding elastic members 15 to engage in the corresponding locking holes 31 of the opposite side of the LCD panel 30. Thus, the LCD panel 30 is mounted to the bezel 10. Most of the LCD panel 30 is located at the opening 12 of the bezel 10. Screws (not shown) are inserted through the mounting holes 17 of the bezel 10 to engage in the corresponding screw holes of the cover 50. The elastic portions 154 of the elastic members 15 absorb vibrations during movement of the LCD device.

In disassembly, the screws 25, 27 are released from the LCD panel 30. The LCD panel 30 is then removed from the bezel 10. The avoiding cutouts 23 of the flanges 21 give access for extension and use of tools therein such as a screwdriver when assembling or disassembling the LCD panel 30.

In a second embodiment of the present invention, the mounting plate 13, the elastic members 15, and the orientating tabs may be formed at corresponding places of the cover 50. Then, the cutouts 23 may be defined in the flanges 52 of the cover 50, and the covering tabs 54 may extend from the flanges 21 of the bezel 10.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment of the invention.

What is claimed is:

1. A liquid crystal display device, comprising:
a bracket comprising a bezel, and a cover mounted to the bezel, one of the bezel and the cover comprising an elastic member mounted to a side thereof; and
a liquid crystal display panel, a side of the liquid crystal display panel mounted to the elastic member.

2. The liquid crystal display device as claimed in claim 1, wherein the elastic member comprises a fixing portion mounted to the one of the bezel and the cover, and an elastic portion for mounting the first side of the liquid crystal display panel.

3. The liquid crystal display device as claimed in claim 2, wherein the elastic member further comprises a slanting connecting portion connected between the fixing portion and the elastic portion.

4. The liquid crystal display device as claimed in claim 2, wherein a locking hole is defined in the corresponding side of the liquid crystal display panel, a through-hole is defined in the elastic portion of the elastic member, a screw is inserted through the through-hole of the elastic member to engage in the locking hole of the liquid crystal display device.

5. The liquid crystal display device as claimed in claim 2, wherein the bezel defines an opening therein, the fixing portion of the elastic member is mounted to the bezel at a corresponding side of the opening.

6. The liquid crystal display device as claimed in claim 1, wherein the one of the bezel and the cover further comprises a mounting plate mounted to an opposite side thereof, for mounting an opposite side of the liquid crystal display panel.

7. The liquid crystal display device as claimed in claim 6, wherein a plurality of through-holes is defined in the mounting plate, a plurality of locking holes is defined in the corresponding side of the liquid crystal display panel, screws are inserted through the through-holes of the mounting plate to engage in the corresponding locking holes of the liquid crystal display panel.

8. The liquid crystal display device as claimed in claim 6, wherein the bezel defines an opening therein, the mounting plate is mounted to the bezel at a corresponding side of the opening.

9. The liquid crystal display device as claimed in claim 8, wherein four orientating tabs perpendicular to the mounting plate extend up from the bezel adjacent four corners of the opening.

10. A bracket for mounting a liquid crystal display panel, the bracket comprising:
a bezel; and
a cover mounted to the bezel;
wherein one of the bezel and the cover comprising an elastic member mounted to a side thereof, for mounting a corresponding side of the liquid crystal display panel.

11. The bracket as claimed in claim 10, wherein the elastic member comprises a fixing portion mounted to the one of the bezel and the cover, and an elastic portion for mounting the corresponding side of the liquid crystal display panel.

12. The bracket as claimed in claim 11, wherein the elastic member further comprises a slanting connecting portion connected between the fixing portion and the elastic portion.

13. The bracket as claimed in claim 12, wherein a through-hole is defined in the elastic portion of the elastic member, for a screw being inserted therethrough to engage with the liquid crystal display panel.

14. The bracket as claimed in claim 12, wherein the bezel defines an opening therein, the fixing portion of the elastic member is mounted to the bezel at a corresponding side of the opening.

15. The bracket as claimed in claim 10, wherein the one of the bezel and the cover further comprises a mounting plate mounted to an opposite side thereof, for mounting an opposite side of the liquid crystal display device panel.

16. The bracket as claimed in claim 15, wherein a plurality of through-holes is defined in the mounting plate, for a plurality of screws being inserted therethrough to engage with the corresponding side of the liquid crystal display panel.

17. The bracket as claimed in claim 15, wherein the bezel defines an opening therein, the mounting plate is mounted to the bezel at a corresponding side of the opening.

18. The bracket as claimed in claim 17, wherein four orientating tabs perpendicular to the mounting plate extend up from the bezel adjacent four corners of the opening.
